(19) United States
(12) Patent Application Publication
(10) Pub. No.: US 2013/0073467 A1
(43) Pub. Date: Mar. 21, 2013

(54) METHOD AND SYSTEM FOR CONDUCTING FINANCIAL TRANSACTIONS USING MOBILE DEVICES

(71) Applicant: Rosa M. Underwood, Washington, DC (US)

(72) Inventor: Rosa M. Underwood, Washington, DC (US)

(73) Assignee: VERIZON PATENT AND LICENSING INC., Basking Ridge, NJ (US)

(21) Appl. No.: 13/234,983

(22) Filed: Sep. 16, 2011

(51) Int. Cl. G06Q 20/00; G06Q 40/00

(52) U.S. Cl. 705/71; 705/44; 705/43

(57) ABSTRACT

An approach for conducting financial transactions using mobile devices is described. Authentication transaction information for a financial transaction event is received from a mobile device. A determination is made as to whether the mobile device is registered with a financial service. A message that includes an access code for completing the financial transaction event at a banking device associated with the financial service is generated if the mobile device is registered with the financial service.

### BACKGROUND INFORMATION

Service providers are continually challenged to deliver value and convenience to consumers by providing compelling network services and advancing the underlying technologies. One area of interest has been the development of services and technologies relating to financial services. For example, in recent years, automated teller machines (ATMs) have allowed the clients of financial institutions to have access to certain financial transactions in a public space without the need for in-person interactions, reducing costs associated with such interactions for both financial institutions and their clients. These financial transactions may, for instance, include making deposits, initiating payments, transfer of funds between associated accounts, etc. Unfortunately, ATM cards required for these ATM transactions are easily lost, misplaced, or stolen, increasing costs associated with theft and card replacement.

Therefore, there is a need for an effective approach for accessing financial services at ATMs and other banking devices.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of conducting financial transactions using mobile devices, according to an exemplary embodiment;

FIG. 2 is a diagram of the components of a financial transaction manager, according to an exemplary embodiment;

FIG. 3 is a diagram of the components of a banking device, according to an exemplary embodiment;

FIG. 4 is a flowchart of a process for conducting financial transactions using mobile devices, according to an exemplary embodiment;

FIG. 5 is a flowchart of a process for completing a financial transaction event using a key for encrypting access, according to an exemplary embodiment;

FIG. 6 is a flowchart of a process for completing a financial transaction event at a banking device, according to an exemplary embodiment;

FIGS. 7A and 7B are diagrams of a user interface of a mobile device for conducting financial transactions, according to various exemplary embodiments;

FIGS. 8A and 8B are diagrams of a user interface of a banking device for completing a financial transaction event at the banking device, according to various exemplary embodiments;

FIG. 9 is a diagram of a computer system that can be used to implement various exemplary embodiments; and

FIG. 10 is a diagram of a chip set that can be used to implement an embodiment of the invention.

### DESCRIPTION OF THE PREFERRED EMBODIMENT

An apparatus, method and software for conducting financial transactions using mobile devices are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

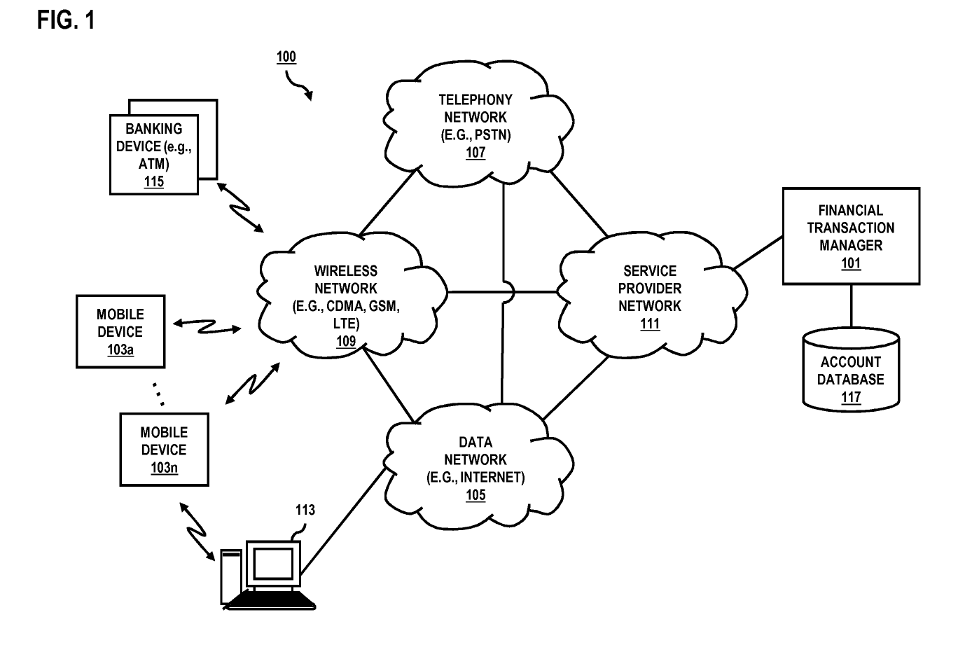

FIG. 1 is a diagram of a system capable of conducting financial transactions using mobile devices, according to an exemplary embodiment. For the purpose of illustration, the system 100 employs a financial transaction manager 101 that is configured to provide coded access, using a mobile device, to financial services at automated teller machines (ATMs) or other banking devices. These financial services may, for instance, be initiated using one or more user devices (e.g., mobile devices 103) over one or more networks (e.g., data network 105, telephony network 107, wireless network 109, etc.). According to one embodiment, services including financial transactions conducted using mobile devices may be part of managed services supplied by a service provider (e.g., a wireless communication company) as a hosted or subscription-based service made available to users of the mobile devices 103 through a service provider network 111. As shown, the financial transaction manager 101 may be a part of or connected to the service provider network 111. According to another embodiment, the financial transaction manager 101 may be include within or connected to a computer device 113, a banking device 115 (or banking devices 115), the mobile devices 103, etc. While specific reference will be made thereto, it is contemplated that the system 100 may embody many forms and include multiple and/or alternative components and facilities. Financial transaction manager 101, in some embodiments, can provide effective security and loss prevention for the clients of financial institutions through coded access performed, for instance, at the banking device 115 without the need for physical banking cards.

In certain embodiments, the financial transaction manager 101 may include or have access to an account database 117. For example, the financial transaction manager 101 may access the account database 117 to acquire account information associated with a client of a particular financial institution. Account information may, for instance, include usernames, passwords (or passcodes), personal identification numbers (PINs), and other information associated with the client (e.g., name, address, birth date, social security number, etc.).

As mentioned, in recent years, ATMs have enabled the clients of financial institutions to conduct a variety of financial transactions in a public space without the need for a human cashier, clerk, or bank teller. As such, ATMs have drastically reduced costs associated with traditional financial transactions involving in-person interactions for both financial institutions and their clients. For example, ATMs can operate 24 hours per day at the convenience of clients, are cheaper to maintain (as compared to large facilities), and are more readily available. As such, financial institutions are able to decrease the need for employing additional staff and for leasing large facilities. Moreover, clients are provided faster and more convenient access to financial services, mitigating costs associated with time spent in long lines as well as traveling to and from banking facilities. Financial transactions that may, for instance, be performed at an ATM include depositing funds, withdrawing funds, initiating payments, transfer of funds between associated accounts, etc. However, as indicated, ATMs are typically associated with issues of lost, misplaced, or stolen cards, such as increasing costs associated with theft (e.g., identity, financial, etc.) and card replacement.

To address this issue, the system 100 of FIG. 1 introduces the capability to provide coded access to financial transactions using mobile devices. By way of example, the financial transaction manager 101 may received authenticated transaction information for a financial transaction event from the mobile device 103, generate a message that includes an access code for completing the financial transaction at the banking device 115 associated with a financial service if the mobile device 103 is registered with the financial service. The financial transaction manager 101 may then initiate transmission of the message to the mobile device 103 so that the message along with the access code may be utilized by a user of the mobile device 103 (or a client of the financial service) to complete the transaction event at the banking device 115. The authenticated transaction information may, for instance, include preselected options associated with the financial transaction event, such as the requested service type (e.g., withdrawal, deposit, payments, etc.), the requested amount (e.g., cash amount to be withdrawn), or banking devices 115 at which the performance of requested services may be completed (e.g., a nearby ATM). In some embodiments, the preselected options may include a selection of the banking device 115 by the user of the mobile device 103 (or the client of the financial service). The mobile device 103 may, for instance, advantageously include a cellular phone and the banking device 115 may include an ATM. In this way, clients of the financial service can avoid having to carrying around an additional device, card, etc., to mitigate the risk of theft or loss.

By way of another example, the banking device 115 may detect presence of the mobile device 103 and establish communication with the mobile device 103 (e.g., upon detecting the presence of the mobile device 103) over a wireless link. Detection may, for instance, be perform using a variety of technologies, such as those of near field communication (NFC), Bluetooth, or infrared techniques. The banking device 115 may then receive a transaction code, from the mobile device 103 (e.g., over the wireless link), associated with the financial transaction event and initiate completion of the financial transaction event to be performed at the banking device 115. In various embodiments, the wireless link may be over a short-range wireless network, such as NFC, Bluetooth, or infrared. The following scenarios illustrate typical situations which the financial transaction manager 101 can be more effective in providing financial services at the banking device 115.

In one scenario, a user may interact with a financial service application, via the user's cellular phone (e.g., the mobile device 103), in order to withdraw cash from a bank in which the user has an account. The application may initially prompt the user for a username and a PIN to log into a financial service associated with the application. The information provided by the user (and the cellular phone) is then authenticated, for instance, based on the PIN provided along with a device identifier associated with the user's cellular phone. As an example, the financial transaction manager 101 may require that the user and the cellular phone (e.g., via the device identifier) be registered with the financial service in order for authentication of transaction information to be successful. Upon login, the user may be presented with a number of options, including various service types, valid request amounts, methods of receiving a confirmation/receipt, or ATMs at which the performance of requested services may be completed. As such, the user may, for instance, request to withdraw money from any one of the nearby ATMs. The authenticated transaction information for the requested transaction may be transmitted to the financial transaction manager 101 from the user's cellular phone. Since the cellular phone is registered with the financial service, the financial transaction manager 101 may generate and transmit a message including an access code (to the user's cellular phone) for completing the requested transaction at any one of the selected ATMs. Thus, the user may then use the access code on the cellular phone to obtain cash from one of the selected ATMs. The user may, for instance, obtain the requested funds by manually entering a code for the transaction (e.g., the access code) into an ATM, or by holding the cellular phone near the ATM to transmit the code (e.g., the access code) to the ATM from the cellular phone over a wireless link.

In another scenario, the ATM from which a financial transaction event may be completed can offer users several menu options. The ATM may, for instance, provide menu options for financial services using a traditional ATM card or a “virtual card” that utilizes the access codes provided by the financial transaction manager 101. Although the ATM can be configured to automatically detect presence of a cellular phone, such as those registered with the financial service (e.g., via the device identifier of the cellular phone), the ATM may also monitor and detect the presence of the cellular phone when the user has selected the “virtual card” option. In this way, processing and power resources associated with monitoring may be reduced, which may, for instance, be advantageous in a number of situations (e.g., when the ATM is running on batteries due to a local power outage). Further, the ATM may establish communication with the cellular phone, upon detection, over a wireless link. As discussed, the wireless link may be over a short-range wireless network, such as NFC, Bluetooth, or infrared. The ATM may then receive a code for the particular transaction from the cellular phone and complete the transaction if, for instance, the code received from the cellular phone matches an access code provided to the ATM for the particular transaction by the financial transaction manager 101.

In certain embodiments, the financial transaction manager 101 may generate a key including an encrypted version of the access code. The key may then be transmitted to the banking device 115. Thus, when the banking device 115 receives a transaction code for a particular financial transaction event from the mobile device 103, the transaction code may be compared with the key to provide verification for the financial transaction event. If, for instance, the banking device 115 deems that the transaction code and the key are a match (through the performance of a comparison by the financial transaction manager 101 or the banking device 115), the completion of the financial transaction may be initiated at the banking device 115. It is contemplated that any authentication procedure can be performed.

It is noted that the mobile devices 103 may be any type of mobile terminal including a mobile handset, mobile station, mobile unit, multimedia computer, multimedia tablet, communicator, netbook, Personal Digital Assistants (PDAs), smartphone, media receiver, etc. It is also contemplated that the mobile devices 103 may support any type of interface for supporting the presentment or exchange of data. In addition, mobile devices 103 may facilitate various input means for receiving and generating information, including touch screen capability, keyboard and keypad data entry, voice-based input mechanisms, accelerometer (e.g., shaking the mobile device 103), and the like. Any known and future implementations of mobile devices 103 are applicable. It is noted that, in certain embodiments, the mobile devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of mobile devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each mobile device 103, i.e., IP addresses that are accessible to devices connected to the service provider network 111 as facilitated via a router. It is further noted that the banking device 115 may also support the above interfaces, facilitate the above various input means, and establish the above communication sessions based on the variety of above technologies.

In various embodiments, the access code may be valid for completing the financial transaction event at the banking device 115 for a predetermined duration of time. By way of example, the financial transaction manager 101 may assign a time limit for the access code to a short period of time (e.g., an hour, ten minutes, etc.). The time limit may, for instance, be based on the type of financial transaction event (e.g., deposit, withdrawal, payments), the request amount associated with the financial transaction event, methods of receiving a confirmation/receipt (e.g., via printing at the banking device 115, email, etc.), the banking devices 115 from which the financial transaction may be completed, etc. In this way, security and loss prevention associated with these financial transaction events may be reduced since the access codes may only be valid for a short period of time. Consequently, if the mobile device 103 is lost or stolen, the time limit may prevent the mobile device 103 from being used at the banking device 115 (e.g., to withdraw funds).

In other embodiments, the banking device 115 may broadcast location information and/or service information associated with the banking device 115. For example, the banking device 115 may provide the financial transaction manager 101 with updates (e.g., real-time updates) with respect to its location information and/or service information. In one scenario, the banking device 115 may be a mobile ATM or other mobile banking device. As such, frequent updates with respect to its location information would be relevant for users. In another scenario, a local power outage may cause the banking device 115 to run on batteries. The banking device 115 may thus calculate and report the time duration in which the services of the banking device 115 will stay available based on an estimation of the life of the batteries (e.g., how long the batteries will last) or the duration of the power outage (e.g., how long the power outage will last).

In a further embodiment, the selection of the banking device 115 by the user may be based on the broadcasted location information and/or service information. As an example, the location information and/or the service information may be provided to the user, via the mobile device 103, when the menu options for available banking devices 115 are presented to the user. One or more mobile devices 103a-103n can be configured to receive such broadcasts using various criteria (e.g., based on proximity to the banking device 115). As discussed, the authentication transaction information may include preselected options associated with the financial transaction event. Accordingly, information associated with the selection of the banking device 115 by the user may be included in the authentication transaction information along as one of the preselected options.

In some embodiments, the financial transaction manager 101, the mobile devices 103, the banking device 115, and other elements of the system 100 may be configured to communicate via the service provider network 111. According to certain embodiments, one or more networks, such as the data network 105, the telephony network 107, and/or the wireless network 109, may interact with the service provider network 111. The networks 105-109 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-109 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-109 may include components and facilities to provide for signaling and/or bearer communications between the various components or facilities of the system 100. In this manner, the networks 105-109 may embody or include portions of a signaling system 7 (SS7) network, Internet protocol multimedia subsystem (IMS), or other suitable infrastructure to support control and signaling functions.

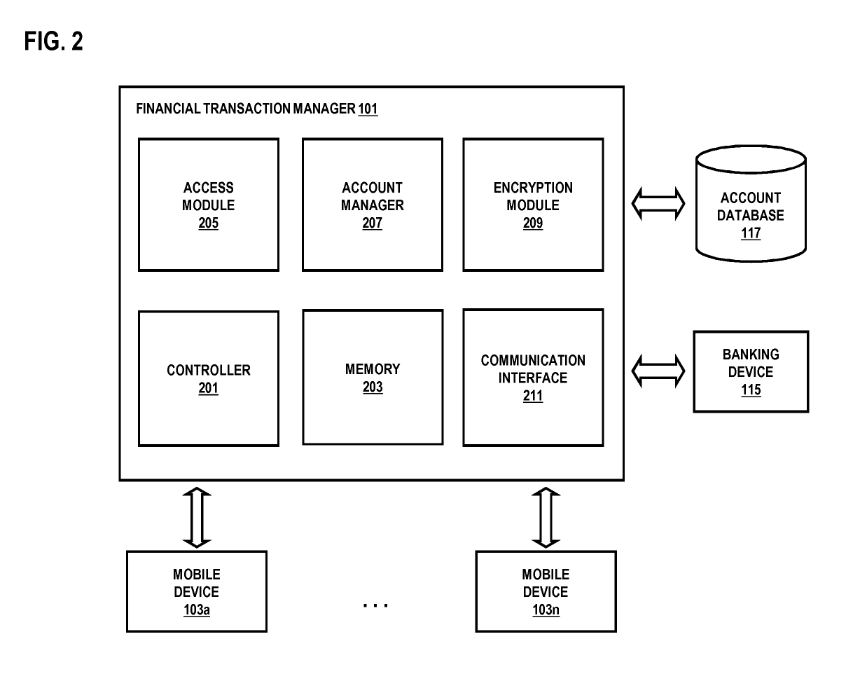

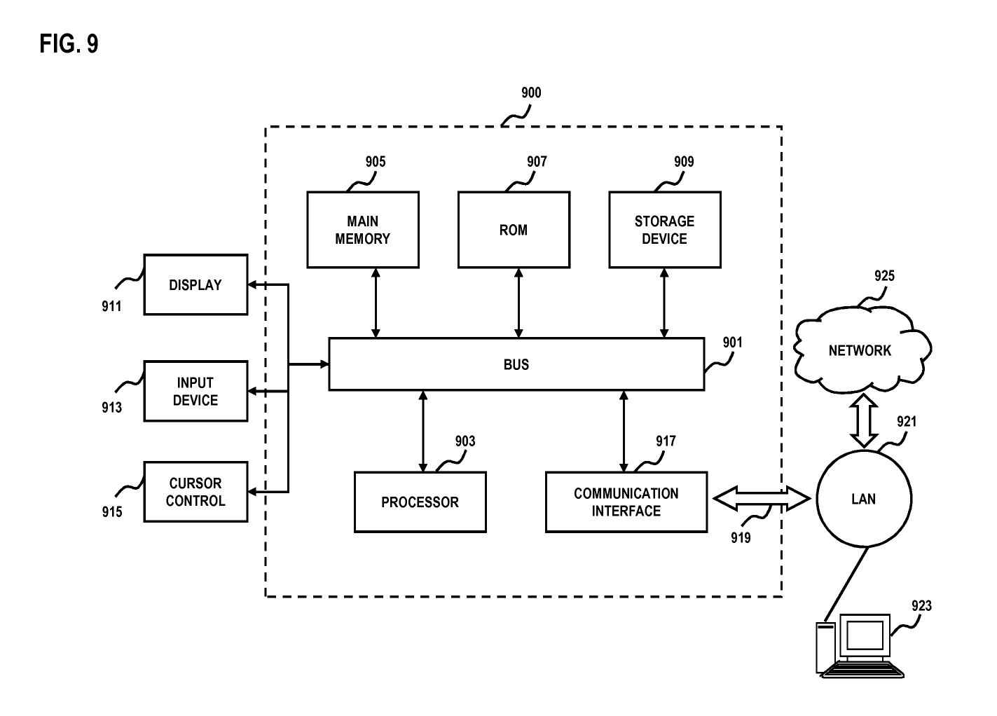

FIG. 2 is a diagram of the components of a financial transaction manager, according to an exemplary embodiment. The financial transaction manager 101 may comprise computing hardware (such as described with respect to FIG. 9), as well as include one or more components configured to execute the processes described herein for providing coded access services of the system 100. It is contemplated that the functions of these components may be combined in one or more components or performed by other components of equivalent functionality. In one implementation, the financial transaction manager 101 includes a controller (or processor) 201, memory 203, an access module 205, an account manager 207, an encryption module 209, and a communication interface 211.

The controller 201 may execute at least one algorithm for executing functions of the financial transaction manager 101. For example, the controller 201 may interact with the access module 205 to verify that received transaction information for a financial transaction event from the mobile device 103 is indeed authenticated. The access module 205 may also work with the account manager 207 to determine whether the mobile device 103 is registered with a financial service. As mentioned, the device identifier associated with the mobile device 103 along with other information (e.g., username, password, PIN) may be utilize to authenticate transaction information and to determine whether the mobile device 103 is registered. If, for instance, the account manager 207 determines that the mobile device 103 is registered with the financial service, the access module 205 may then generate a message that includes an access code for completing the financial transaction event at the banking device 115.

The controller 201 may also direct the encryption module 209 to generate a key including an encrypted version of the access code and thereafter initiate transfer of the key to the banking device 115 to be used for determining whether the financial transaction event should be completed at the banking device 115 (e.g., based on whether a transaction code provided by the mobile device 103 upon detection by the banking device 115, or by the user, matches the key). In various embodiments, the encryption module 209 may also encrypt the key itself prior to transmission of the key to the banking device 115. It is noted that any encryption techniques may be utilized to encrypt the message, the key, the access code, etc. By way of example, the access code may be encrypted using a public key encryption scheme, a private key encryption scheme, or a combination thereof.

The controller 201 may further utilize the communication interface 211 to communicate with other components of the financial transaction manager 101, the mobile devices 103, the banking device 115, and other components of the system 100. The communication interface 211 may include multiple means of communication. For example, the communication interface 211 may be able to communicate over short message service (SMS), multimedia messaging service (MMS), internet protocol, instant messaging, voice sessions (e.g., via a phone network), email, or other types of communication. According to one embodiment, such methods may be used to receive the authentication transaction information and/or transmit, to the mobile device 103, the message including the access code.

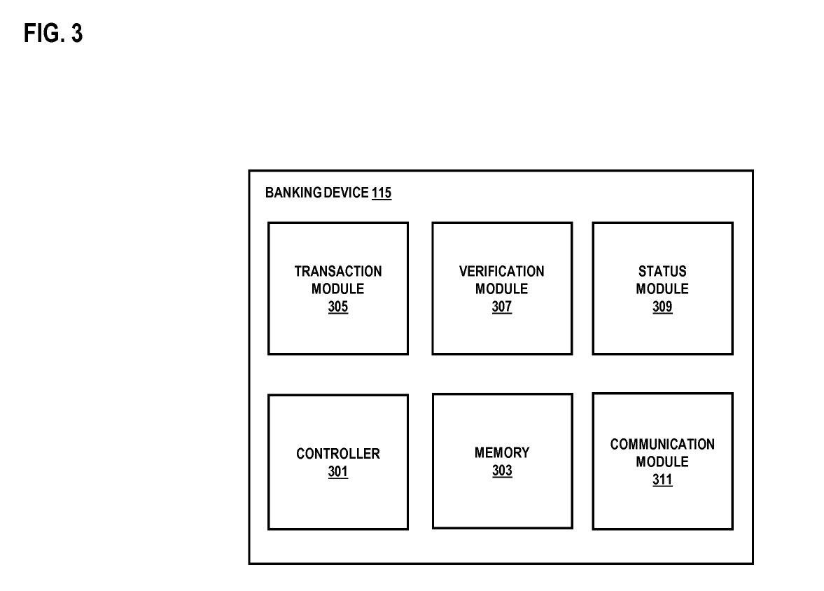

FIG. 3 is a diagram of the components of a banking device, according to an exemplary embodiment. The banking device 115 may comprise computing hardware (such as described with respect to FIG. 9), as well as include one or more components configured to execute the processes described herein for providing coded access services of the system 100. It is contemplated that the functions of these components may be combined in one or more components or performed by other components of equivalent functionality. In one implementation, the banking device 115 includes a controller (or processor) 301, memory 303, a transaction module 305, a verification module 307, a status module 309, and a communication module 311.

The controller 301 may execute at least one algorithm for executing functions of the banking device 115. For example, the controller 301 may work with the transaction module 305 to detect, at the banking device 115, presence of the mobile device 103. The transaction module 305 may then establish, via the communication module 311, communication with the mobile device over a wireless link. As mentioned, in some embodiments, the wireless link may be over a short-range wireless network, such as NFC, Bluetooth, or infrared. Upon establishing the communication, the mobile device 103 may transmit a transaction code associated with a financial transaction event to the banking device 115. Accordingly, the transaction module 305 may receive the transaction code through the communication module 311.

The transaction module 305 may have also received a key that includes an encrypted version of an access code for the financial transaction event. Thus, the transaction module 305 may interact with the verification module 307, via the controller 301, to determine whether the received transaction code matches with the key. If, for instance, it is determined that there is a match, the transaction module 305 may initiate completion of the financial transaction event to be performed at the banking device 115.

In addition, the controller 301 may direct the status module 309 to determine location information and/or service information associated with the banking device 115, which may be broadcasted to the financial transaction manager 101, the mobile devices 103, etc. As mentioned, such information may be important in various circumstances (e.g., mobile ATMs, power outage, etc.) and may be utilized by the user or the financial transaction manager 101 to select particular banking devices 115 from which a financial transaction event may be completed.

As indicated, the broadcasting along with other communications may be perform using the communication module 311 to communicate with other components of the banking device 115, the financial transaction manager 101, the mobile devices 103, and other components of the system 100. The communication module 311 may include multiple means of communication. For example, the communication module 311 may be able to communicate over short message service (SMS), multimedia messaging service (MMS), internet protocol, instant messaging, voice sessions (e.g., via a phone network), email, or other types of communication. According to one embodiment, such methods may be used to receive the key, at the banking device 115, that includes the encrypted version of the access code from the financial transaction manager 101, to receive the transaction code from the mobile device 103 (or from the user of the mobile device 103), or to broadcast the location information and/or the service information.

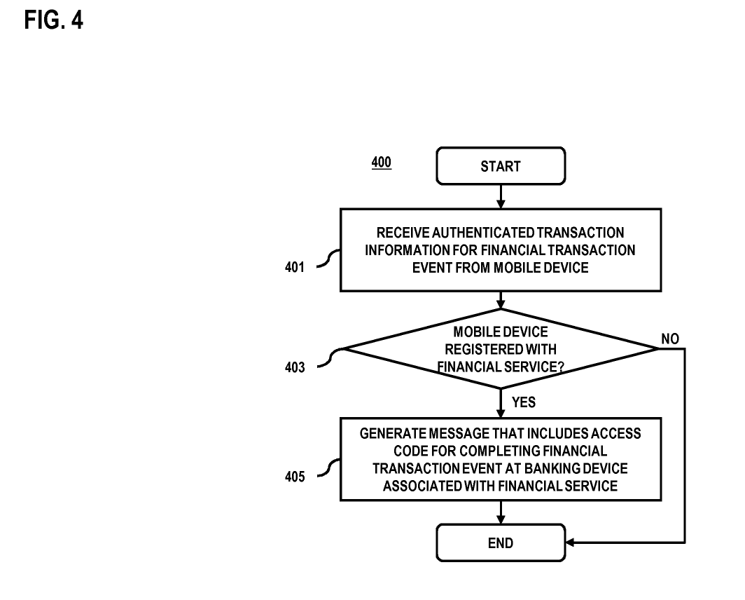

FIG. 4 is a flowchart of a process for conducting financial transactions using mobile devices, according to an exemplary embodiment. For the purpose of illustration, process 400 is described with respect to FIG. 1. It is noted that the steps of the process 400 may be performed in any suitable order, as well as combined or separated in any suitable manner. In step 401, the financial transaction manager 101 may receive authenticated transaction information for a financial transaction event from a mobile device 103. As provided, the authentication transaction information may, for instance, include preselected options associated with the financial transaction event, such as the requested service type (e.g., withdrawal, deposit, payments, etc.), the requested amount (e.g., cash amount to be withdrawn), methods of receiving a confirmation/receipt, or banking devices 115 at which the performance of requested services may be completed (e.g., a nearby ATM). Moreover, the preselected options may include a selection of the banking device 115 by a user of the mobile device 103. As mentioned, the mobile device 103 may include a cellular phone and the banking device may include an ATM.

In step 403, the financial transaction manager 101 may determine whether the mobile device 103 is registered with a financial service. If, for instance, it is determined that the mobile device is registered, the financial transaction manager 101 may, as in step 405, generate a message that includes an access code for completing the financial transaction event at the banking device 115 associated with the financial service. In addition, to provide the mobile device 103 (or the user) with the access code, the financial transaction manager 101 may transmit the message to the mobile device 103.

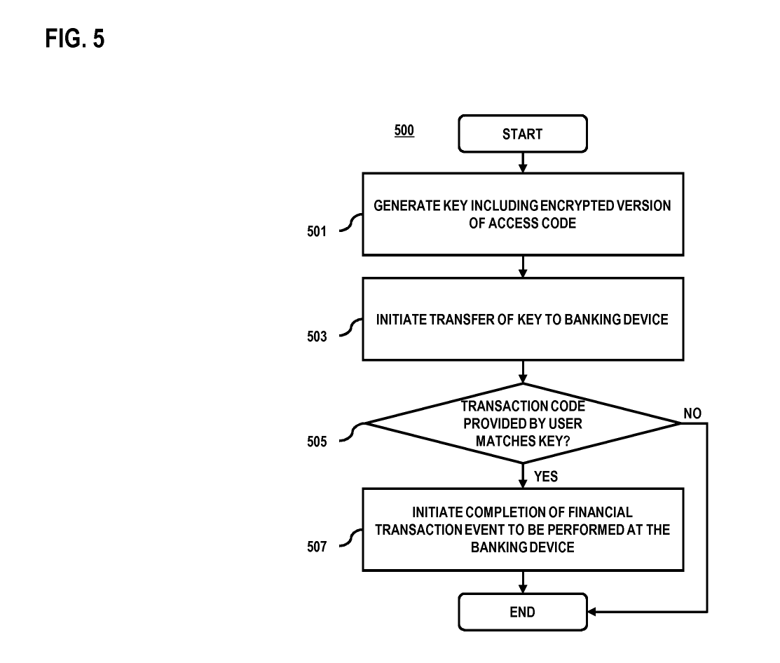

FIG. 5 is a flowchart of a process for completing a financial transaction event using a key for encrypting access, according to an exemplary embodiment. For the purpose of illustration, process 500 is described with respect to FIG. 1. It is noted that the steps of the process 500 may be performed in any suitable order, as well as combined or separated in any suitable manner. In step 501, the financial transaction manager 101 may generate a key including an encrypted version of the access code. As noted, any encryption techniques may be utilized to encrypt the message, the key, the access code, etc. By way of example, the access code may be encrypted using a public key encryption scheme, a private key encryption scheme, or a combination thereof.

In step 503, the financial transaction manager 101 may initiate transfer of the key to the banking device 115. Subsequent, the key may be utilized, for instance, by the banking device 115 to determine whether a transaction code provided by the mobile device 103 (or the user of the mobile device 103) for the financial transaction event is a proper transaction code for completing the financial transaction event. As provided, in step 505, such a determination is made based on whether the transaction code matches the key. If, for instance, there is a match, the banking device 115 may, as in step 507, initiate completion of the financial transaction event to be performed at the banking device 115.

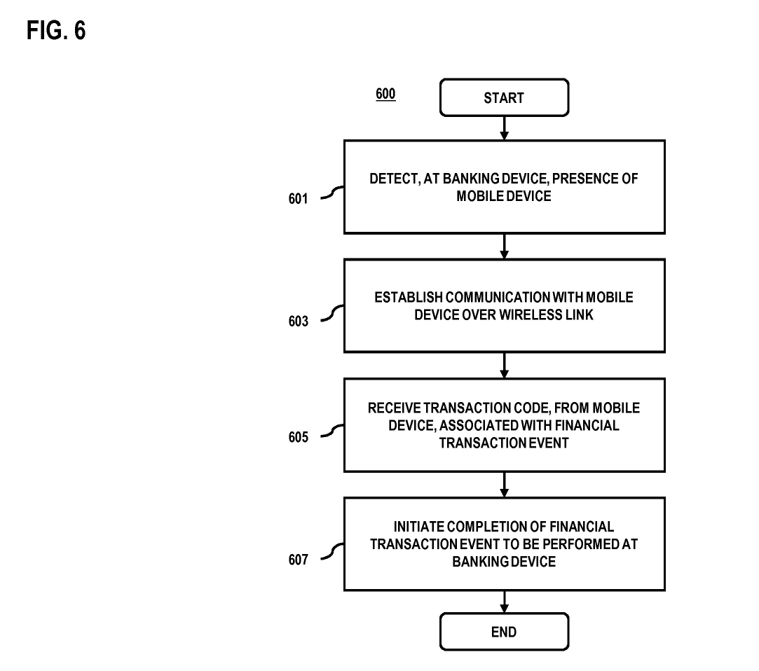

FIG. 6 is a flowchart of a process for completing a financial transaction event at a banking device, according to an exemplary embodiment. For the purpose of illustration, process 600 is described with respect to FIG. 1. It is noted that the steps of the process 600 may be performed in any suitable order, as well as combined or separated in any suitable manner. In step 601, the banking device 115 may detect presence of the mobile device 103. As discussed, the presence of the mobile device 103 may detected via constant monitoring or monitoring activated through user action. By way of example, the banking device 115 may not initiate monitoring until the user has selected a particular menu option (e.g., selecting a “virtual card” option on the banking device 115).

Upon detection, the banking device 115 may, as in step 603, establish communication with the mobile device 103 over a wireless link. As mentioned, the wireless link may be over a short-range wireless network, such as NFC, Bluetooth, or infrared. In step 605, the banking device 115 may receive a transaction code, from the mobile device 103, associated with a financial transaction event. In one scenario, the transaction code may be compared with a key associated for the financial transaction event. If, for instance, the transaction code matches the key, the banking device 115 may, as in step 607, initiate completion of the financial transaction event to be performed at the banking device 115.

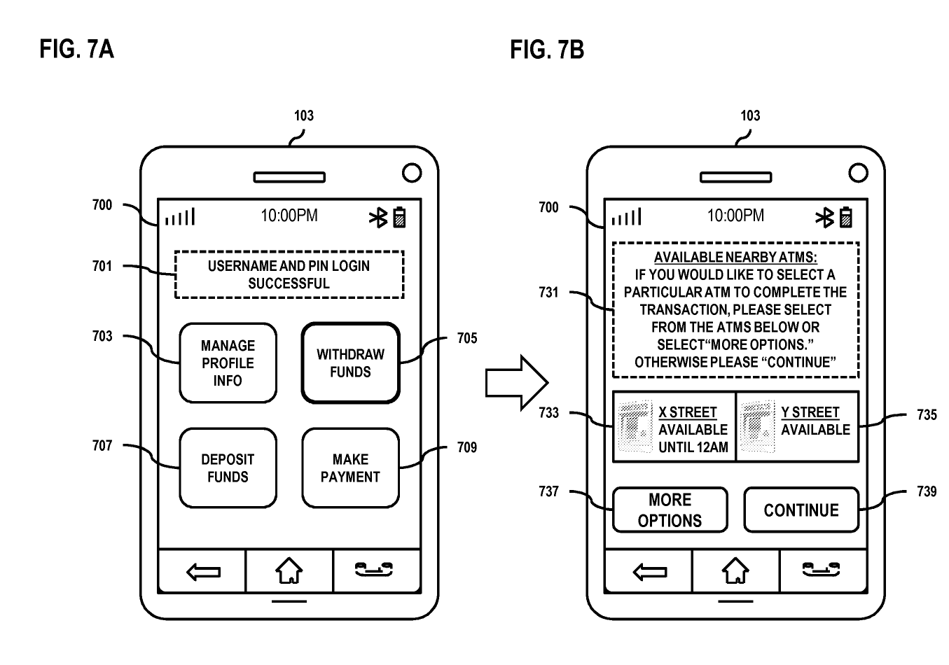

FIGS. 7A and 7B are diagrams of a user interface of a mobile device for conducting financial transactions using mobile devices, according to various exemplary embodiments. For illustrative purposes, the diagrams are described with reference to the system 100 of FIG. 1. For instance, FIG. 7A is a diagram of the mobile device 103 with the user interface 700 featuring a prompt 701 and menu options 703, 705, 707, and 709 (e.g., “Manage Profile Information,” “Withdraw Funds,” “Deposit Funds,” and “Make Payment”). As shown, the user has logged successful into a financial transaction application associated with the user interface 700 using a username and a PIN. In this case, the user has selected the menu option 705 to “Withdraw Funds.”

Based on the selection, as illustrated in FIG. 7B, the user is presented with available nearby ATMs, as indicated in prompt 731. The user may either select one or more particular ATMs from which funds can be withdrawn by selecting either menu options 733 or 735. As presented, the ATM on “X Street” is only available until 12:00 A.M. while the ATM on “Y Street” will continue to be available (e.g., available 24 hours a day). The availability of the presented ATMs may, for instance, be based on location information and/or service information broadcasted by the presented ATMs. By way of example, the ATM on “X Street” may have experienced a local power outage and is currently running on batteries. Based on one or more predetermined criteria (e.g., battery life, duration of power outage, etc.), the ATM on “X Street” may have broadcasted an estimation as to the continued availability of its services to provide users with such information. Alternatively, the user may forego any particular ATM selections and select either menu options 737 or 739 (e.g., “More Options or “Continue”). Based on the user's actions, the user may subsequent be provided with a message that includes an access code, which the user may use to complete the withdrawal of funds at an ATM of the user's choice.

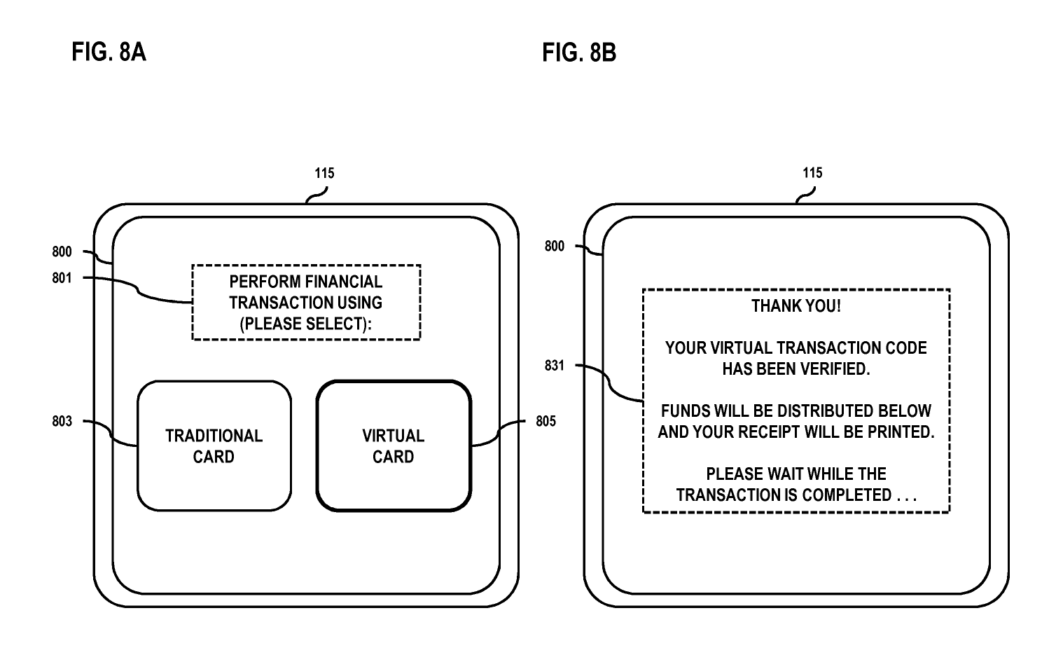

FIGS. 8A and 8B are diagrams of a user interface of a banking device for completing a financial transaction event at the banking device, according to various exemplary embodiments. For illustrative purposes, the diagrams are described with reference to the system 100 of FIG. 1. For instance, FIG. 8A is a diagram of the banking device 115 with the user interface 800 featuring a prompt 801 and menu options 803 and 805 (e.g., “Traditional Card” and “Virtual Card”). As shown, the user has selected to perform a financial transaction using the “virtual card” approach.

As illustrated in FIG. 8B, the completion of the financial transaction is being initiated (e.g., prompt 831). In this case, the user had previously selected to withdraw funds. After selection of the “virtual card” option, the banking device 115 may have detected the presence of the user's mobile device 103 and received a transaction code for the financial transaction from the mobile device 103 after establishing communication with the mobile device 103 over a wireless link. Alternatively, the user may have provided the transaction code by entering the transaction code into the banking device 115 (e.g., via a keyboard of the banking device 115). Accordingly, the financial transaction may be deemed complete once the funds are distributed to the user and the receipt for the financial transaction is printed as the banking device 115, for instance, as selected by the user.

As discussed, effective security and loss prevention are provided by using mobile devices to conduct financial transactions (e.g., through coded access). For example, by utilizing the “virtual card” option to complete the financial transaction, clients of the financial service can decrease the risk of theft or loss since these clients no longer need to carry around additional devices, cards, etc. Moreover, because the access codes may be restricted to a particular time period/duration as well as to particular banking devices, such financial risks are further mitigated. Additional advantages include benefits for the environment (e.g., plastic use reduction) and increased convenience for clients (e.g., faster ATM transactions, knowledge of ATM locations and availability, etc.).

The processes described herein for conducting financial transactions using mobile devices may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 9 is a diagram of a computer system that can be used to implement various exemplary embodiments. The computer system 900 includes a bus 901 or other communication mechanism for communicating information and one or more processors (of which one is shown) 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk, flash storage, or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. Additional output mechanisms may include haptics, audio, video, etc. An input device 913, such as a keyboard including alphanumeric and other keys, is coupled to the bus 901 for communicating information and command selections to the processor 903. Another type of user input device is a cursor control 915, such as a mouse, a trackball, touch screen, or cursor direction keys, for communicating direction information and command selections to the processor 903 and for adjusting cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

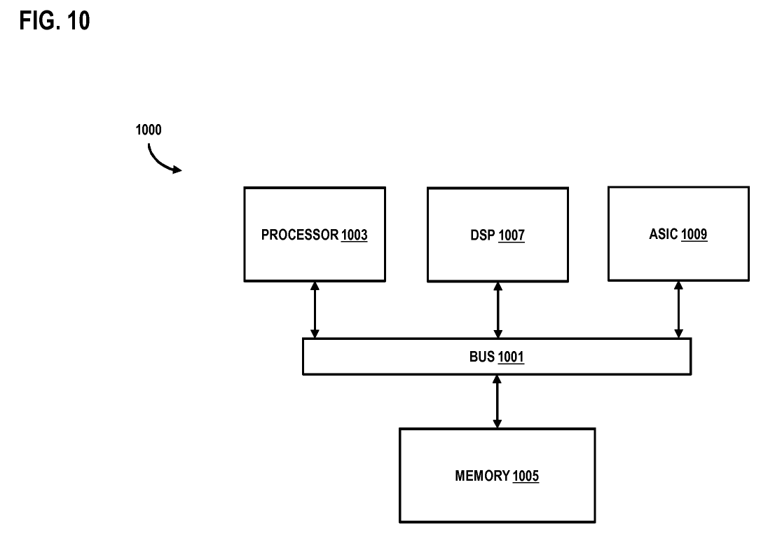

FIG. 10 illustrates a chip set or chip 1000 upon which an embodiment of the invention may be implemented. Chip set 1000 is programmed to enable conducting of financial transactions using mobile devices as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of enabling conducting of financial transactions using mobile devices.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to enable conducting of financial transactions using mobile devices. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
receiving authenticated transaction information for a financial transaction event from a mobile device;
determining, with a processor, whether the mobile device is registered with a financial service;
receiving real-time updates from a plurality of banking devices associated with the financial service including location information and time duration in which services of any banking device running only on batteries will stay available; and
generating, with the processor, a message that includes an access code for completing the financial transaction event at a certain banking device associated with the financial service if the mobile device is registered with the financial service,
wherein the location information and the time duration in which services of any banking device running only on batteries will stay available are used to select the certain banking device from which the financial transaction event may be completed, and
wherein the banking device running only on batteries calculates the time duration in which services of the banking device will stay available based on an estimation of the life of the batteries.

2. A method according to claim 1, further comprising:
generating a key including an encrypted version of the access code; and
initiating transfer of the key to the certain banking device,
wherein the completion of the financial transaction event at the certain banking device is initiated if the access code provided at the certain banking device by a user of the mobile device matches the key.

3. A method according to claim 1, wherein the authenticated transaction information includes preselected options associated with the financial transaction event.

4. (canceled)

5. A method according to claim 1, wherein the mobile device includes a cellular phone and the certain banking device includes an automated teller machine (ATM).

6. A method according to claim 1, wherein the access code is valid, for completing the financial transaction event at the certain banking device, for a predetermined duration of time.

7. An apparatus comprising:
at least one processor; and
at least one memory including computer program code for one or more programs,
the at least one memory and the computer program code configured to, with the at least one processor, cause the apparatus to perform at least the following,
receive authenticated transaction information for a financial transaction event from a mobile device;
determine whether the mobile device is registered with a financial service;
receive real-time updates from a plurality of banking devices associated with the financial service including location information and time duration in which services of any banking device running only on batteries will stay available; and
generate a message that includes an access code for completing the financial transaction event at a certain banking device associated with the financial service if the mobile device is registered with the financial service,
wherein the location information and the time duration in which services of any banking device running only on batteries will stay available are used to select the certain banking device from which the financial transaction event may be completed, and
wherein the banking device running only on batteries calculates the time duration in which services of the banking device will stay available based on an estimation of the life of the batteries.

8. An apparatus according to claim 7, wherein the apparatus is further caused to:
generate a key including an encrypted version of the access code; and
initiate transfer of the key to the certain banking device,
wherein the completion of the financial transaction event at the certain banking device is initiated if the access code provided at the certain banking device by a user of the mobile device matches the key.

9. An apparatus according to claim 7, wherein (a) the authenticated transaction information includes preselected options associated with the financial transaction event, (b) the preselected options include a selection of the certain banking device by a user of the mobile device, and (c) the access code is valid, for completing the financial transaction event at the certain banking device, for a predetermined duration of time.

10. An apparatus according to claim 7, wherein the mobile device includes a cellular phone and the certain banking device includes an automated teller machine (ATM).

11. A method comprising:
broadcasting location information and real-time updates from a banking device associated with a financial service, wherein the banking device is running only on batteries and the real-time updates include time duration in which services of the banking device running only on batteries will stay available;
detecting, at the banking device, presence of a mobile device;
establishing communication with the mobile device over a wireless link;
receiving, by a processor, an access code, from the mobile device, associated with a financial transaction event;
receiving, by the processor, a key including an encrypted version of the access code from a financial service; and
initiating, by the processor, completion of the financial transaction event to be performed at the banking device, wherein
the access code is generated for a financial transaction event relating to authenticated transaction information from the mobile device for completion of the financial transaction event at the banking device,
the authenticated transaction information includes preselected options associated with the financial transaction event,
the preselected options include a selection of the banking device by the user,
the selection of the banking device is based on the broadcasted location information and the time duration in which services of the banking device running only on batteries will stay available, and
the banking device running only on batteries calculates the time duration in which services of the banking device will stay available based on an estimation of the life of the batteries.

12-14. (canceled)

15. A method according to claim 11, wherein the access code is valid, for completing the financial transaction event at the banking device, for a predetermined duration of time.

16. A method according to claim 11, wherein the mobile device includes a cellular phone and the banking device includes an automated teller machine (ATM).

17. An apparatus comprising:
at least one processor; and
at least one memory including computer program code for one or more programs,
the at least one memory and the computer program code configured to, with the at least one processor, cause the apparatus to perform at least the following,
broadcast location information and real-time updates from a banking device associated with a financial service, wherein the banking device is running only on batteries and the real-time updates include time duration in which services of the banking device running only on batteries will stay available;
detect, at a banking device, presence of a mobile device;
establish communication with the mobile device over a wireless link;
receive an access code, from the mobile device, associated with a financial transaction event;
receive a key including an encrypted version of the access code from a financial service; and
initiate completion of the financial transaction event to be performed at the banking device, wherein
the access code is generated for a financial transaction event relating to authenticated transaction information from the mobile device for completion of the financial transaction event at the banking device,
the authenticated transaction information includes preselected options associated with the financial transaction event,
the preselected options include a selection of the banking device by the user,
the selection of the banking device is based on the broadcasted location information and the time duration in which services of the banking device running only on batteries will stay available, and
the banking device running only on batteries calculates the time duration in which services of the banking device will stay available based on an estimation of the life of the batteries.

18. An apparatus according to claim 17, wherein the access code is valid, for completing the financial transaction event at the banking device, for a predetermined duration of time.

19. (canceled)

20. An apparatus according to claim 17, wherein the mobile device includes a cellular phone and the banking device includes an automated teller machine (ATM).
